(19) United States
(12) Patent Application Publication
(10) Pub. No.: US 2015/0206270 A1
(43) Pub. Date: Jul. 23, 2015

(54) SYSTEM AND METHOD FOR WIRELESSLY SHARING GRAPHICS PROCESSING RESOURCES AND GPU TETHERING INCORPORATING THE SAME

(71) Applicant: Nvidia Corporation, Santa Clara, CA (US)

(72) Inventor: Vinay Brahmaroutu, Pune (IN)

(73) Assignee: Nvidia Corporation, Santa Clara, CA (US)

(21) Appl. No.: 14/160,761

(22) Filed: Jan. 22, 2014

(51) Int. Cl. G06T 1/20

(52) U.S. Cl. CPC G06T 1/20; G09G 2370/16

(57) ABSTRACT

A system and method for wirelessly sharing graphics processing resources and a mobile device incorporating the system or the method. In one embodiment, the system includes: (1) a call evaluator operable to receive a graphics call from an application and determine whether the call should be wirelessly directed to a shared graphics processing resource and (2) a tether interface associated with the call evaluator and operable to receive calls from the call evaluator that the call evaluator has determined should be wirelessly directed to the shared graphics processing resource and wirelessly direct the calls to the shared graphics processing resource.

### TECHNICAL FIELD

This application is directed, in general, to wireless networking and, more specifically, to sharing graphics processing resources over a wireless network.

### BACKGROUND

Mobile devices such as cell phones, smartphones, pads and tablets are ubiquitous. While they were originally introduced to provide rudimentary functionality, such as telephony and text messaging, they have now evolved to the point that they have begun to replicate the functions of physically much larger computers, such as desktop personal computers. Accordingly, mobile devices are beginning to be used for gaming, desktop publishing and graphics and video editing. These are particularly computation- and graphics-intensive applications, and test the general- and special-purpose processing and storage limits of mobile devices.

Supporting the ever-intensifying use of mobile devices is an evermore-capable wireless network infrastructure, making its presence known in both cellular and wireless Internet access (Wi-Fi) forms. Consequently, mobile devices are able to make higher-bandwidth, more reliable wireless connections in more places than ever before possible.

As a result of all of the above, more-capable mobile devices (smartphones, pads and tablets in particular) have begun to spawn short-range wireless networks of their own, allowing other devices to be “tethered” to the more-capable mobile devices, which then serve as proxies for access to the wireless network infrastructure. Bluetooth and Wi-Fi Direct are two notable technologies that make possible such short-range peer-to-peer wireless networks, sometimes called personal area networks (PANs) or piconets. Not only can two smartphones, pads and tablets be tethered to one another via Bluetooth or Wi-Fi Direct, but a host of less-capable devices can be tethered as well, such as cell phones, earphones, headsets, speakers, displays, gaming controllers and remotes, sensors and actuators, to name just a few.

### SUMMARY

One aspect provides a system for wirelessly sharing graphics processing resources. In one embodiment, the system includes: (1) a call evaluator operable to receive a graphics call from an application and determine whether the call should be wirelessly directed to a shared graphics processing resource and (2) a tether interface associated with the call evaluator and operable to receive calls from the call evaluator that the call evaluator has determined should be wirelessly directed to the shared graphics processing resource and wirelessly direct the calls to the shared graphics processing resource.

Another aspect provides a method of wirelessly sharing graphics processing resources. In one embodiment, the method includes: (1) receiving a graphics call from an application executing in a first device, (2) determining whether the call should be wirelessly directed to a shared graphics processing resource of a second device, (3) wirelessly directing the call to the shared graphics processing resource and (4) wirelessly receiving results from the shared graphics processing resource into the first device.

Yet another aspect provides a mobile device. In one embodiment, the mobile device includes: (1) communication circuitry, (2) a central processing unit coupled to the communication circuitry, (3) memory coupled to the central processing unit, (4) a call evaluator associated with the central processing unit and operable to receive a graphics call from an application executing on the central processing unit and determine whether the call should be wirelessly directed to a shared graphics processing resource of another device and (5) a tether interface associated with the call evaluator and operable to receive calls from the call evaluator that the call evaluator has determined should be wirelessly directed to the shared graphics processing resource and wirelessly direct the calls to the shared graphics processing resource via the communication circuitry.

### BRIEF DESCRIPTION

Reference is now made to the following descriptions taken in conjunction with the accompanying drawings, in which:

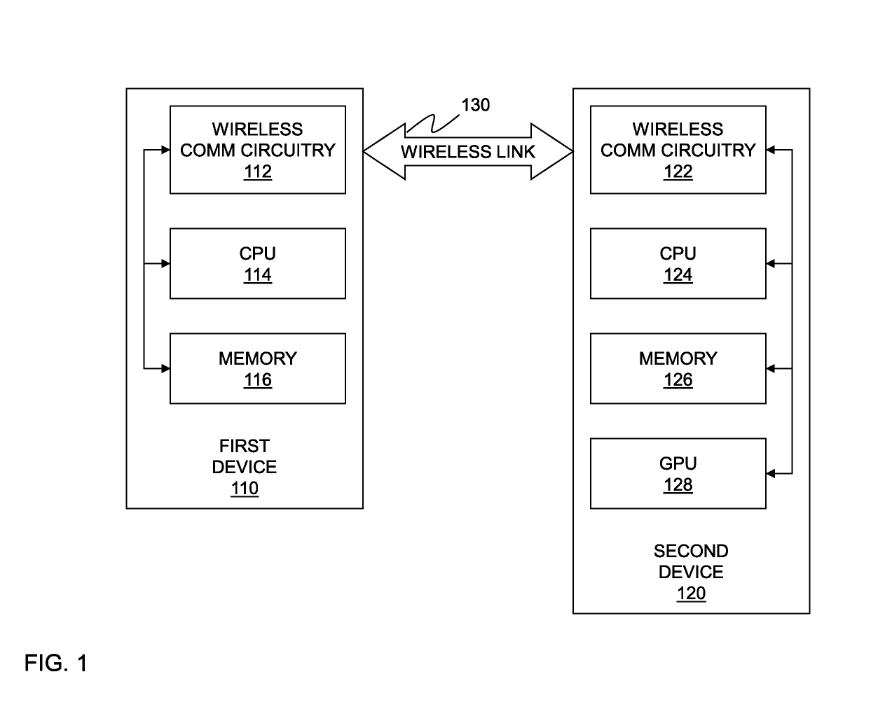

FIG. 1 is a block diagram of one embodiment of a network in which a system or method for wirelessly sharing graphics processing resources may be carried out;

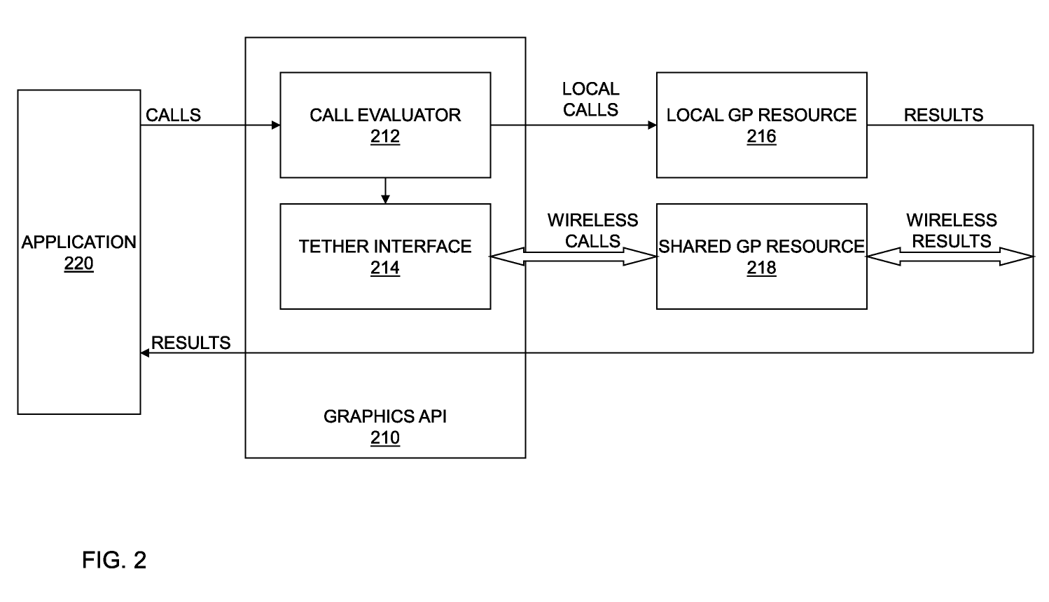

FIG. 2 is a block diagram of one embodiment of a system for wirelessly sharing graphics processing resources; and

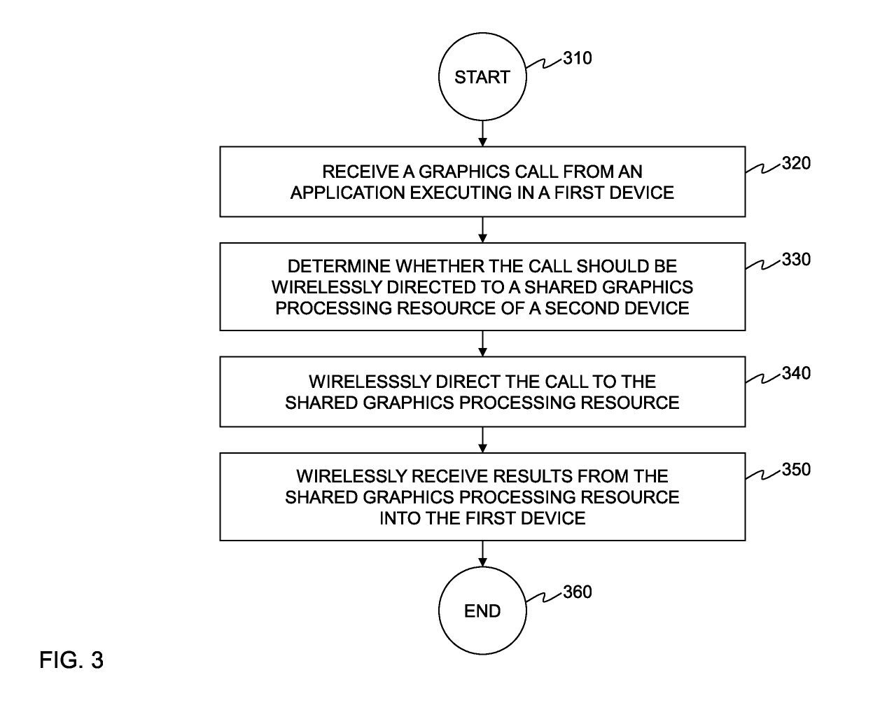

FIG. 3 is a flow diagram of one embodiment of a method of wirelessly sharing graphics processing resources.

### DETAILED DESCRIPTION

As stated above, Bluetooth and Wi-Fi Direct allow more-capable mobile devices to share their access to the wireless network infrastructure. Also as stated above, mobile devices are beginning to be used for gaming, desktop publishing and graphics and video editing. It is realized herein, however, that peer-to-peer resource sharing need not be limited to network access. It is further realized herein that not all peers are created equal; some peers have more processing resources than others. It is therefore realized herein that peer-to-peer sharing can and should extend to processing resources. It is more specifically realized that graphics processing resources, such as a graphics processing unit (GPU), can be shared wirelessly. It is realized that the wireless sharing of graphics processing resources need not be limited to mobile devices, but that wireless sharing can occur between a mobile device and a fixed device (such as a desktop computer), or between two fixed devices.

Introduced herein are various embodiments of a system and method for wirelessly sharing graphics processing resources. The novel system and method may be colloquially termed as enabling “GPU tethering.” Embodiments of the system and method to be illustrated herein operate in a “transparent” manner, such that applications running on a first device need not be modified to take advantage of the graphics processing resources of a second device to which the first device is tethered. Indeed, the applications may be “unaware” that calls they make to a graphics application programming interface (API) on the first device are being handled by the graphics processing resources of the second device over a wireless network.

FIG. 1 is a block diagram of one embodiment of a network in which a system or method for wirelessly sharing graphics processing resources may be carried out. The network encompasses a first device 110 and a second device 120 and employs a wireless link 130 to allow communication between the first and second devices 110, 120.

The first device 110 has wireless communication circuitry 112, a CPU 114 and memory 116. An unreferenced bus couples the wireless communication circuitry 112, the CPU 114 and the memory 116 together for communication thereamong. The second device 120 has wireless communication circuitry 122, a CPU 124 and memory 126. An unreferenced bus couples the wireless communication circuitry 122, the CPU 124 and the memory 126 together for communication thereamong. The first device 110 is assumed to be less capable in terms of graphics processing capability than the second device 120. In the context of FIG. 1, it will be presumed that this disparity stems from the fact that the first device 110 lacks a GPU, whereas the second device 120 has a GPU 128. The unreferenced bus of the second device 120 couples the GPU 128 as well as the wireless communication circuitry 122, the CPU 124 and the memory 126 together for communication thereamong.

It should be noted that, though the first device 110 is less capable in terms of graphics processing capability than the second device 120, it is likely not wholly without such capability. Devices lacking a GPU typically perform graphics processing in their CPU. While far slower and less efficient, a CPU can perform graphics operations. However, it will be assumed that the user of the first device 110 would much rather process graphics using the superior graphics processing resources of the second device 120.

In a manner to be described in greater detail in conjunction with FIGS. 2 and 3, applications running on the CPU 114 and processing data that is stored, at least to some extent, in the memory 116 will be afforded the benefit of access to the graphics processing resources of the second device 120, principally its GPU 128. In certain embodiments, the applications do not require modification to be afforded this benefit.

A few examples will illustrate why graphics processing resource sharing can be advantageous. In a first example, the user of the first device 110 may have taken a photograph using the first device 110 and wish to edit the resulting image before uploading it to the World Wide Web. With the benefit of the system or method introduced herein the user can cause the first device 110 to be tethered to the second device 120 and thereafter execute a graphics editor in the first device, but have access to the GPU 128 of the second device 120.

Incidentally, the user may own the second device 120, or it may be owned by a friend. In a second example, the user of the first device 110 may be playing a cloud game along with the user of the second device 120. Instead of diminishing the experience of the user of the first device 110 and perhaps placing him at a disadvantage relative to the user of the second device 120, the GPU 128 of the second device 120 may be shared between the first and second devices 110, 120, bringing the two devices 110 into greater parity, at least in terms of graphics processing capability, and potentially leveling the playing field. In a third example, the user of the first device 110 may be willing to tolerate its inferior graphics processing capability in carrying out a graphics-intensive task, but may not be willing to tolerate the associated battery drain. By tethering the first device 110 to the second device 120 and gaining access to its GPU 128, the user of the first device 110 can not only extend the life of the battery of the first device 110 by completing the task more quickly, but also shift the load required to perform graphics processing from the battery of the first device 110 to the battery of the second device 120.

Having described a representative network and highlighted some examples of how graphics processing resource sharing may be advantageous, various embodiments of the system and method introduced herein will now be described. FIG. 2 is a block diagram of one embodiment of a system for wirelessly sharing graphics processing resources. The illustrated embodiment of the system takes the form of a graphics API 210 executing in a device that is to share the graphics processing resource of another device. As those skilled in the pertinent art are familiar, a graphics API is operable to handle calls for graphics processing, the calls taking the form of commands having a standard syntax. For example, the syntax may be that of the well-known OpenGL convention. Other graphics conventions, both standards-based and proprietary, fall within the scope of the invention.

The graphics API 210 includes a call evaluator 212. The call evaluator 212 is operable to receive a call from an application 220 and determine whether the call should be wirelessly directed to a shared graphics processing resource. Calls that the call evaluator 212 determines should not be wirelessly directed to a shared graphics processing resource are termed “local calls” and routed to a local graphics processing resource 216.

The graphics API 210 also includes a tether interface 214 associated with the call evaluator 212. The tether interface 214 is operable to receive calls from the call evaluator 212 that the call evaluator 212 has determined should be wirelessly directed to a shared graphics processing resource and wirelessly directs those calls (termed “wireless calls”) to a shared graphics processing resource 218. Whether handled by the local graphics processing resource 216 or the shared graphics processing resource 218, results are returned to the graphics API 210, and the graphics API 210 returns the results to the application 220. Results handled by the shared graphics processing resource 218 are returned wirelessly, as FIG. 2 indicates.

In one embodiment, the call evaluator 212 is operable to determine how calls should be directed based on the type of call. For example, calls for graphics to be displayed on a screen may be directed to the local graphics processing resource 216, while calls for graphics to be manipulated (e.g., rendered) may be directed to the shared graphics processing resource 218. In another embodiment, the call evaluator 212 is operable to determine how calls should be directed based on estimates of times required to process the graphics data that is to be processed. For example, complex graphics processing to be carried out on relatively little data may make more sense to carry out using the shared graphics processing resource 216, because wireless transmission latency is negligible relative to processing latency. On the other hand, straightforward graphics processing carried out on large data sets may make more sense to carry out using the local graphics processing resource 216, because the time required to transmit the large data set wirelessly and receive the results wirelessly may exceed the additional time required to process the data locally, despite the relatively modest graphics processing capability available locally.

As FIG. 2 indicates, the operation of the graphics API in directing calls to the local graphics processing resource 216 or the shared graphics processing resource 218, as the case may be, is “invisible” to the application generating the calls, as the application only interacts with the graphics API 210 in making calls and receiving results. Those skilled in the pertinent art will realize, however, that application “transparency” is not essential. Thus, embodiments of the system and method introduced herein accommodate applications that have been modified to make explicit use of shared graphics processing resources via wireless communication.

FIG. 3 is a flow diagram of one embodiment of a method of wirelessly sharing graphics processing resources. The method begins in a start step 310. In a step 320, a graphics call is received from an application executing in a first device. In a step 330, it is determined whether the call should be wirelessly directed to a shared graphics processing resource of a second device. In a step 340, assuming the call should be wirelessly directed to the shared graphics processing resource, the call is wirelessly directed to the shared graphics processing resource. In a step 350, results are wirelessly received from the shared graphics processing resource into the first device. The method ends in an end step 360.

Those skilled in the art to which this application relates will appreciate that other and further additions, deletions, substitutions and modifications may be made to the described embodiments.

What is claimed is:

1. A system for wirelessly sharing graphics processing resources, comprising:
a call evaluator operable to receive a graphics call from an application and determine whether said call should be wirelessly directed to a shared graphics processing resource; and
a tether interface associated with said call evaluator and operable to receive calls from said call evaluator that said call evaluator has determined should be wirelessly directed to said shared graphics processing resource and wirelessly direct said calls to said shared graphics processing resource.

2. The system as recited in claim 1 wherein said call evaluator and said tether interface are embodied in a graphics application programming interface of a first device.

3. The system as recited in claim 1 wherein said call evaluator is further operable to direct said call to a local graphics processing resource if said call evaluator determines that said call should not be wirelessly directed to said shared graphics processing resource.

4. The system as recited in claim 1 wherein said call evaluator and said tether interface are associated with a first mobile device.

5. The system as recited in claim 4 wherein said shared graphics processing resource is associated with a second mobile device.

6. The system as recited in claim 1 wherein said shared graphics processing resource is a GPU.

7. The system as recited in claim 1 wherein said tether interface is operable to interact with communication circuitry selected from the group consisting of:
Bluetooth communication circuitry, and
Wi-Fi Direct communication circuitry.

8. A method of wirelessly sharing graphics processing resources, comprising:
receiving a graphics call from an application executing in a first device;
determining whether said call should be wirelessly directed to a shared graphics processing resource of a second device;
wirelessly directing said call to said shared graphics processing resource; and
wirelessly receiving results from said shared graphics processing resource into said first device.

9. The method as recited in claim 8 wherein an application programming interface carries out said receiving and said determining.

10. The method as recited in claim 8 further comprising directing said call to a local graphics processing resource of said first device if said call evaluator determines that said call should not be wirelessly directed to said shared graphics processing resource.

11. The method as recited in claim 8 wherein said first device is a first mobile device.

12. The method as recited in claim 11 wherein said second device is a second mobile device.

13. The method as recited in claim 8 wherein said shared graphics processing resource is a GPU.

14. The method as recited in claim 8 wherein said wirelessly directing comprises interacting with communication circuitry selected from the group consisting of:
Bluetooth communication circuitry, and
Wi-Fi Direct communication circuitry.

15. A mobile device, comprising:
communication circuitry;
a central processing unit coupled to said communication circuitry;
memory coupled to said central processing unit;
a call evaluator associated with said central processing unit and operable to receive a graphics call from an application executing on said central processing unit and determine whether said call should be wirelessly directed to a shared graphics processing resource of another device; and
a tether interface associated with said call evaluator and operable to receive calls from said call evaluator that said call evaluator has determined should be wirelessly directed to said shared graphics processing resource and wirelessly direct said calls to said shared graphics processing resource via said communication circuitry.

16. The mobile device as recited in claim 15 wherein said call evaluator and said tether interface are embodied in a graphics application programming interface of said mobile device.

17. The mobile device as recited in claim 15 wherein said call evaluator is further operable to direct said call to a local graphics processing resource if said call evaluator determines that said call should not be wirelessly directed to said shared graphics processing resource.

18. The mobile device as recited in claim 15 wherein said other device is a second mobile device.

19. The mobile device as recited in claim 15 wherein said shared graphics processing resource is a GPU.

20. The mobile device as recited in claim 15 wherein said communication circuitry is selected from the group consisting of:
Bluetooth communication circuitry, and
Wi-Fi Direct communication circuitry.
